(19) United States
(12) Patent Application Publication
(10) Pub. No.: US 2021/0278540 A1
(43) Pub. Date: Sep. 9, 2021

(54) Noise Filtering System and Method for Solid-State LiDAR

(71) Applicant: OPSYS Tech Ltd., Holon (IL)

(72) Inventors: Niv Maayan, Gealiya (IL); Amit Fridman, Yehud (IL); Itamar Eliyahu, Tel Aviv (IL); Mark J. Donovan, Mountain View, CA (US)

(73) Assignee: OPSYS Tech Ltd., Holon (IL)

(21) Appl. No.: 17/191,641

(22) Filed: Mar. 3, 2021

Related U.S. Application Data
(60) Provisional application No. 62/985,755, filed on Mar. 5, 2020.

(51) Int. Cl. G01S 17/89; G01S 7/481; G01J 1/42; G01S 7/4865; G01S 17/931

(52) U.S. Cl. CPC G01S 17/89; G01S 7/4816; G01S 17/931; G01S 7/4815; G01S 7/4865; G01J 1/4204

(57) ABSTRACT

A system and method of noise filtering light detection and ranging signals to reduce false positive detection of light generated by a light detection and ranging transmitter in an ambient light environment that is reflected by a target scene. A received data trace is generated based on the detected light. An ambient light level is determined based on the received data trace. Valid return pulses are determined by noise filtering, which can for example, by comparing magnitudes of return pulses to a predetermined variable, N, times the determined ambient light level or by comparing magnitudes of return pulses to a sum of the ambient light level and N-times the variance of the ambient light level. A point cloud comprising the plurality of data points with a reduced false positive rate is generated.

### CROSS REFERENCE TO RELATED APPLICATION

The present application is a non-provisional application of U.S. Provisional Patent Application Ser. No. 62/985,755 entitled “Noise Filtering System and Method for Solid-State LIDAR” filed on Mar. 5, 2020. The entire content of U.S. Provisional Patent Application Ser. No. 62/985,755 is herein incorporated by reference.

The section headings used herein are for organizational purposes only and should not to be construed as limiting the subject matter described in the present application in any way.

### INTRODUCTION

Autonomous, self-driving, and semi-autonomous automobiles use a combination of different sensors and technologies such as radar, image-recognition cameras, and sonar for detection and location of surrounding objects. These sensors enable a host of improvements in driver safety including collision warning, automatic-emergency braking, lane-departure warning, lane-keeping assistance, adaptive cruise control, and piloted driving. Among these sensor technologies, light detection and ranging (LiDAR) systems take a critical role, enabling real-time, high-resolution 3D mapping of the surrounding environment.

Most current LiDAR systems used for autonomous vehicles today utilize a small number of lasers, combined with some method of mechanically scanning the environment. Some state-of-the-art LiDAR systems use two-dimensional Vertical Cavity Surface Emitting Lasers (VCSEL) arrays as the illumination source and various types of solid-state detector arrays in the receiver. It is highly desired that future autonomous cars utilize solid-state semiconductor-based LiDAR systems with high reliability and wide environmental operating ranges. These solid-state LiDAR systems are advantageous because they use solid state technology that has no moving parts. However, currently state-of-the-art LiDAR systems have many practical limitations and new systems and methods are needed to improve performance.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates the operation of an embodiment of a LiDAR system of the present teaching implemented in a vehicle.

FIG. 2A illustrates a graph showing a transmit pulse generated by an embodiment of a LiDAR system of the present teaching.

FIG. 2B illustrates a graph showing simulation of a return signal for an embodiment of a LiDAR system of the present teaching.

FIG. 2C illustrates a graph of a simulation showing an average of sixteen return signals for an embodiment of a LiDAR system of the present teaching.

FIG. 3 illustrates a block diagram of an embodiment of a LiDAR system of the present teaching.

FIG. 4 illustrates a flow diagram of an embodiment of a LiDAR measurement method that includes false positive filtering according to the present teaching.

FIG. 5A illustrates a first portion of a received data trace from a known system and method of LiDAR measurement.

FIG. 5B illustrates a second portion of the received data trace from the known system and method of LiDAR measurement.

FIG. 5C illustrates a third portion of the received data trace from the known system and method of LiDAR measurement.

FIG. 5D illustrates a fourth portion of the received data trace from the known system and method of LiDAR measurement.

FIG. 6A illustrates a first portion of a received data trace subject to signal-to-noise ratio filtering according to the present teaching.

FIG. 6B illustrates a second portion of the received data trace subject to signal-to-noise ratio filtering according to the present teaching.

FIG. 6C illustrates a third portion of the received data trace subject to signal-to-noise ratio filtering according to the present teaching.

FIG. 6D illustrates a fourth portion of the received data trace subject to signal-to-noise ratio filtering according to the present teaching.

FIG. 7A illustrates a first portion of a received data trace subject to signal-to-noise ratio filtering according to the present teaching with the measurement at high ambient light conditions.

FIG. 7B illustrates a second portion of the received data trace subject to signal-to-noise ratio filtering according to the present teaching with the measurement at high ambient light conditions.

FIG. 7C illustrates a third portion of the received data trace subject to signal-to-noise ratio filtering according to the present teaching with the measurement at high ambient light conditions.

FIG. 7D illustrates a fourth portion of the received data trace subject to signal-to-noise ratio filtering according to the present teaching with the measurement at high ambient light conditions.

FIG. 8A illustrates a first portion of a received data trace subject to signal-to-noise ratio filtering according to the present teaching with the measurement at low ambient light conditions.

FIG. 8B illustrates a second portion of the received data trace subject to signal-to-noise ratio filtering according to the present teaching with the measurement at low ambient light conditions.

FIG. 8C illustrates a third portion of the received data trace subject to signal-to-noise ratio filtering according to the present teaching with the measurement at low ambient light conditions.

FIG. 9A illustrates a first portion of a received data trace subject to standard deviation filtering according to the present teaching with the measurement at normal ambient light conditions.

FIG. 9B illustrates a second portion of the received data trace subject to standard deviation filtering according to the present teaching with the measurement at normal ambient light conditions.

FIG. 9C illustrates a third portion of the received data trace subject to standard deviation filtering according to the present teaching with the measurement at normal ambient light conditions.

FIG. 9D illustrates a fourth portion of the received data trace subject to standard deviation filtering according to the present teaching with the measurement at normal ambient light conditions.

FIG. 10A illustrates a first portion of a received data trace subject to standard deviation filtering according to the present teaching with the measurement at high ambient light conditions.

FIG. 10B illustrates a second portion of the received data trace subject to standard deviation filtering according to the present teaching with the measurement at high ambient light conditions.

FIG. 10C illustrates a third portion of the received data trace subject to standard deviation filtering according to the present teaching with the measurement at high ambient light conditions.

FIG. 10D illustrates a fourth portion of the received data trace subject to standard deviation filtering according to the present teaching with the measurement at high ambient light conditions.

FIG. 11A illustrates a first portion of a received data trace subject to standard deviation filtering according to the present teaching with the measurement at low ambient light conditions.

FIG. 11B illustrates a second portion of the received data trace subject to standard deviation filtering according to the present teaching with the measurement at low ambient light conditions.

FIG. 12 illustrates various regions of a detector array used in an embodiment of the noise filtering system and method for solid-state LiDAR according to the present teaching where measurement of ambient light and/or background noise are taken with detector elements within the detector array.

FIG. 13 illustrates a detector configuration for an embodiment of the noise filtering system and method for solid-state LiDAR of the present teaching where a second detector or detector array corresponding to a different field-of-view is used for the ambient light and/or background noise measurement

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

The present teaching relates generally to Light Detection and Ranging (LiDAR), which is a remote sensing method that uses laser light to measure distances (ranges) to objects. LiDAR systems generally measure distances to various objects or targets that reflect and/or scatter light. Autonomous vehicles make use of LiDAR systems to generate a highly accurate 3D map of the surrounding environment with fine resolution. The systems and methods described herein are directed towards providing a solid-state, pulsed time-of-flight (TOF) LiDAR system with high levels of reliability, while also maintaining long measurement range as well as low cost.

In particular, the methods and apparatus of the present teaching relates to LiDAR systems that send out a short time duration laser pulse, and then use direct detection of the return pulse in the form of a received return signal trace to measure TOF to the object. Some embodiments of the LiDAR system of the present teaching can use multiple laser pulses to detect objects in a way that improves or optimizes various performance metrics. For example, multiple laser pulses can be used in a way that improves signal-to-noise ratio (SNR). Multiple laser pulses can also be used to provide greater confidence in the detection of a particular object. The numbers of laser pulses can be selected to give particular levels of SNR and/or particular confidence values associated with detection of an object. This selection of the number of laser pulses can be combined with a selection of an individual or group of laser devices that are associated with a particular pattern of illumination in the Field-of-View (FOV).

In some methods according to the present teaching, the number of laser pulses is determined adaptively during operation. Also, in some methods according to the present teaching, the number of laser pulses varies across the FOV depending on selected decision criteria. The multiple laser pulses used in some method according to the present teaching are chosen to have a short enough duration that nothing in the scene can move more than a few millimeters in an anticipated environment. Having such a short duration is necessary in order to be certain that the same object is being measured multiple times. For example, assuming a relative velocity of the LiDAR system and an object is 150 mph, which typical of a head on highway driving scenario, the relative speed of the LiDAR system and object is about 67 meters/sec. In 100 microseconds, the distance between the LiDAR and the object can only change by 6.7 mm, which is on the same order as the typical spatial resolution of a LiDAR. And, also that distance must be small compared to the beam diameter of the LiDAR in the case that the object is moving perpendicular to the LiDAR system at that velocity. The particular number of laser pulses chosen for a given measurement is referred to herein as the average number of laser pulses.

There is a range of distances to surrounding objects in the FOV of a LiDAR system. For example, the lower vertical FOV of the LiDAR system typically sees the surface of the road. There is no benefit in attempting to measure distances beyond the road surface. Also, there is essentially a loss in efficiency for a LiDAR system that always measures out to a uniform long distance (>100 meters) for every measurement point in the FOV. The time lost in both waiting for a longer return pulse, and in sending multiple pulses, could be used to improve the frame rate and/or provide additional time to send more pulses to those areas of the FOV where objects are at long distance. Knowing that the lower FOV almost always sees the road surface at close distances, an algorithm could be implemented that adaptively changes the timing between pulses (i.e., shorter for shorter distance measurement), as well as the number of laser pulses.

The combination of high definition mapping, GPS, and sensors that can detect the attitude (pitch, roll, and yaw) of the vehicle can also provide quantitative knowledge of the roadway orientation which could be used in combination with the LiDAR system to define a maximum measurement distance for a portion of the field-of-view corresponding to the known roadway profile. A LiDAR system according to the present teaching can use the environmental conditions, and data for the provided distance requirement as a function of FOV to adaptively change both the timing between pulses, and the number of laser pulses based on the SNR, measurement confidence, or some other metric.

The other factor that affects the number of pulses used to fire an individual or group of lasers in a single sequence is the measurement time. Embodiments that use laser arrays may include hundreds, or even thousands, of individual lasers. All or some of these individual lasers may be pulsed in a sequence or in a pattern as a function of time in order to interrogate an entire scene. For each laser fired a number (N times), the measurement time increases by at least N. Therefore, measurement time increases by increasing the number of pulse shots from a given laser or group of lasers.

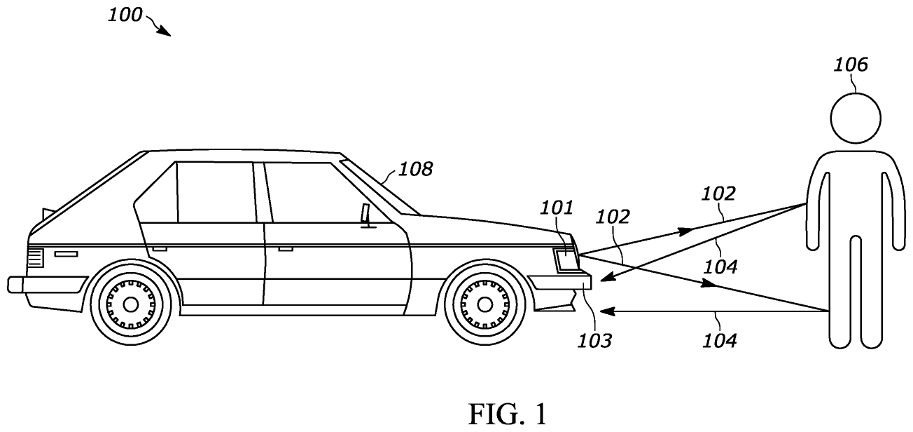

FIG. 1 illustrates the operation of a LiDAR system 100 of the present teaching implemented in a vehicle. The LiDAR system 100 includes a laser projector 101, also referred to as an illuminator, that projects light beams 102 generated by a light source toward a target scene and a receiver 103 that receives the light 104 that reflects from an object, shown as a person 106, in that target scene. In some embodiments, the illuminator 101 comprises a laser transmitter and various transmit optics.

LiDAR systems typically also include a controller that computes the distance information about the object (person 106) from the reflected light. In some embodiments, there is also an element that can scan or provide a particular pattern of the light that may be a static pattern, or a dynamic pattern across a desired range and field-of-view (FOV). A portion of the reflected light from the object (person 106) is received in a receiver. In some embodiments, a receiver comprises receive optics and a detector element that can be an array of detectors. The receiver and controller are used to convert the received signal light into measurements that represent a pointwise 3D map of the surrounding environment that falls within the LiDAR system range and FOV.

Some embodiments of LiDAR systems according to the present teaching use a laser transmitter that includes a laser array. In some specific embodiments, the laser array comprises Vertical Cavity Surface Emitting Laser (VCSEL) devices. These may include top-emitting VCSELs, bottom-emitting VCSELs, and various types of high-power VCSELs. The VCSEL arrays may be monolithic. The laser emitters may all share a common substrate, including semiconductor substrates or ceramic substrates.

In various embodiments, individual lasers and/or groups of lasers using one or more transmitter arrays can be individually controlled. Each individual emitter in the transmitter array can be fired independently, with the optical beam emitted by each laser emitter corresponding to a 3D projection angle subtending only a portion of the total system field-of-view. One example of such a LiDAR system is described in U.S. Patent Publication No. 2017/0307736 A1, which is assigned to the present assignee. The entire contents of U.S. Patent Publication No. 2017/0307736 A1 are incorporated herein by reference. In addition, the number of pulses fired by an individual laser, or group of lasers can be controlled based on a desired performance objective of the LiDAR system. The duration and timing of this sequence can also be controlled to achieve various performance goals.

Some embodiments of LiDAR systems according to the present teaching use detectors and/or groups of detectors in a detector array that can also be individually controlled. See, for example, U.S. Provisional Application No. 62/859,349, entitled “Eye-Safe Long-Range Solid-State LiDAR System”. U.S. Provisional Application No. 62/859,349 is assigned to the present assignee and is incorporated herein by reference. This independent control over the individual lasers and/or groups of lasers in the transmitter array and/or over the detectors and/or groups of detectors in a detector array provide for various desirable operating features including control of the system field-of-view, optical power levels, and scanning pattern.

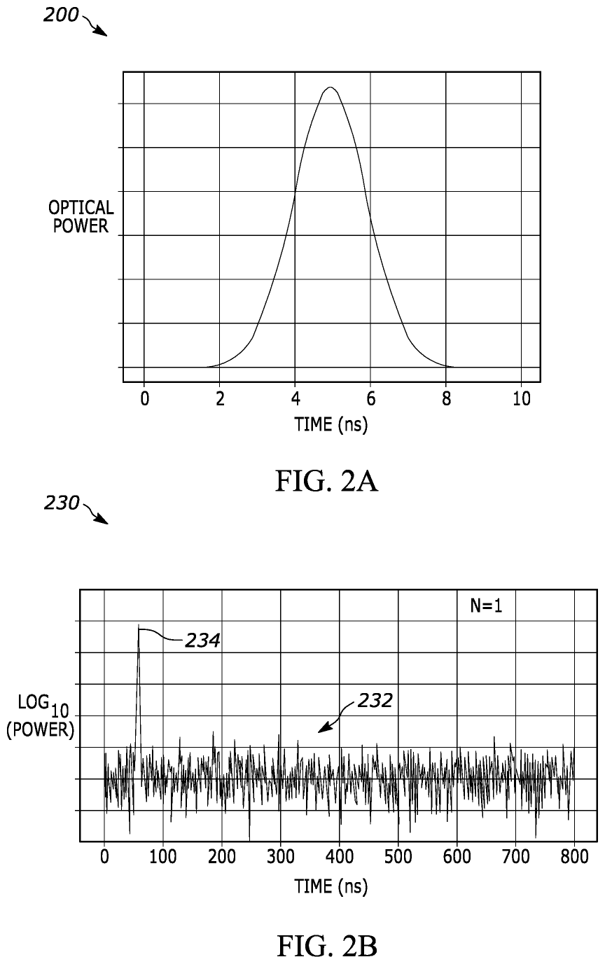

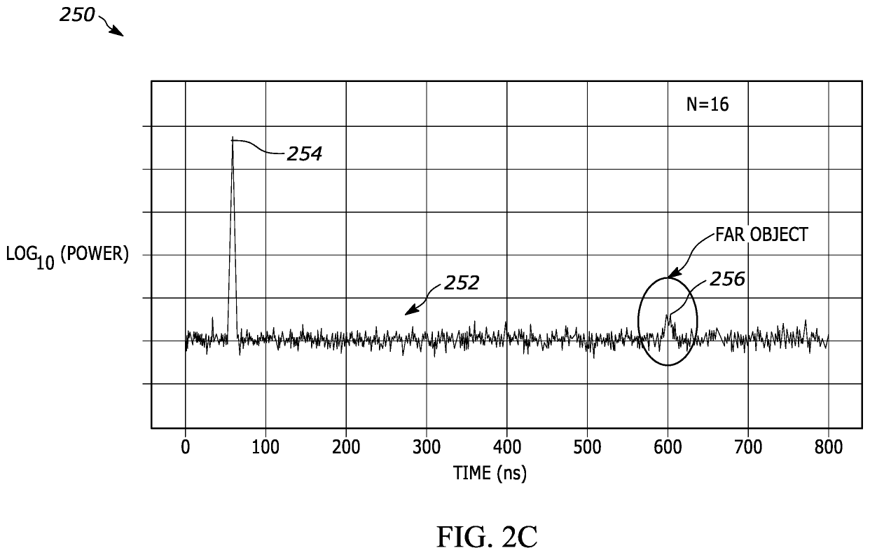

FIG. 2A illustrates a graph 200 of a transmit pulse generated by an embodiment of a LiDAR system of the present teaching. The graph 200 shows the optical power as a function of time for a typical transmit laser pulse in a LiDAR system. The laser pulse is Gaussian in shape as a function of time and typically about five nanoseconds in duration. In various embodiments, the pulse duration takes on a variety of values. In general, the shorter the pulse duration the better the performance of the LiDAR system. Shorter pulses reduce uncertainty in the measured timing of the reflected return pulse. Shorter pulses also allow higher peak powers in the typical situation when eye safety is a constraint. This is, because for the same peak power, shorter pulses have less energy than longer pulses. It should be understood that the particular transmit pulse is one example of a transmit pulse, and not intended to limit the scope of the present teaching in any way.

In order to be able to average multiple pulses to provide information about a particular scene, the time between pulses should be relatively short. In particular, the time between pulses should be faster than the motion of objects in a target scene. For example, if objects are traveling at a relative velocity of 50 m/sec, their distance will change by 5 mm within 100 μsec. Thus, in order to not have ambiguity about the target distance and the target itself, a LiDAR system should complete all pulse averaging where the scene is quasi-stationary and the total time between all pulses is on the order of 100 μsec. Certainly, there is interplay between these various constraints. It should be understood that there are various combinations of particular pulse durations, the number of pulses, and the time between pulses or duty cycle that improve or optimize the measurements. In various embodiments, the specific physical architectures of the lasers and the detectors, and control schemes of the laser firing parameters are combined to achieve a desired performance and/or optimal performance.

FIG. 2B illustrates a graph 230 showing a simulation of a return signal for an embodiment of a LiDAR system of the present teaching. This type of graph is sometimes referred to as a return signal trace. A return signal trace is a graph of a detected return signal from a single transmitted laser pulse. This particular graph 230 is a simulation of a detected return pulse. The LOG₁₀(POWER) of the detected return signal is plotted as a function of time. The graph 230 shows noise 232 from the system and from the environment. There is a clear return pulse peak 234 at ˜60 nanoseconds. This peak 234 corresponds to reflection from an object at a distance of nine meters from the LiDAR system. Sixty nanoseconds is the time it takes for the light to go out to the object and back to the detector when the object is nine meters away from the transmitter/receiver of the LiDAR system. The LiDAR system can be calibrated so that a particular measured time of a peak is associated with a particular target distance.

FIG. 2C illustrates a graph 250 of a simulation of an average of sixteen return signals of an embodiment of a LiDAR system of the present teaching. The graph 250 illustrates a simulation in which a sequence of sixteen returns, each similar to the return signal shown in the graph 230 of FIG. 2B, are averaged. The sequence of sixteen return pules is generated by sending out a sequence of sixteen single pulse transmissions. As can be seen, the spread of the noise 252 is reduced through averaging. In this simulation, noise is varying randomly. The scene (not shown) for the data in this graph is two objects in the FOV, one at nine meters, and one at ninety meters. It can be seen in the graph 250 that there is a first return peak 254 that can be seen at about 60 nanoseconds and a second return peak 256 can be seen at about 600 nanoseconds. This second return peak 256 corresponds to the object located at a distance of ninety meters from the LiDAR system. Thus, each single laser pulse can produce multiple return peaks 254, 256 resulting from reflections off objects that are located at various distances from the LiDAR system. In general, intensity peaks reduce in magnitude with increasing distance from the LiDAR system. However, the intensity of the peaks depends on numerous other factors such as physical size and reflectivity characteristics of the objects. It should be understood that the return signals and averaging conditions described in connection with FIGS. 2B-C are just an example to illustrate the present teaching, and not intended to limit the scope of the present teaching in any way.

One feature of the apparatus of the present teaching is that it is compatible with the use of detector arrays. Various detector technologies may be used to construct the detector array for the LiDAR systems according to the present teaching. For example, Single Photon Avalanche Diode Detector (SPAD) arrays, Avalanche Photodetector (APD) arrays, and Silicon Photomultiplier Arrays (SPAs) can be used. The detector size not only sets the resolution by setting the field-of-view of a single detector, but also relates to the speed and detection sensitivity of each device. State-of-the-art two-dimensional arrays of detectors for LiDAR are already approaching the resolution of VGA cameras, and are expected to follow a trend of increasing pixel density similar to that seen with CMOS camera technology. Thus, smaller and smaller sizes of the detector field-of-view are expected to be realized over time. These small detector arrays allow operation of some embodiments of the LiDAR in a configuration in which a field-of-view of an individual emitter in an emitter array is larger than a field-of-view of an individual detector in a detector array. Thus, the field-of-view of an emitter can cover multiple detectors in some embodiments. It should be understood that the field-of-view of an emitter represents the size and shape of the region illuminated by the emitter.

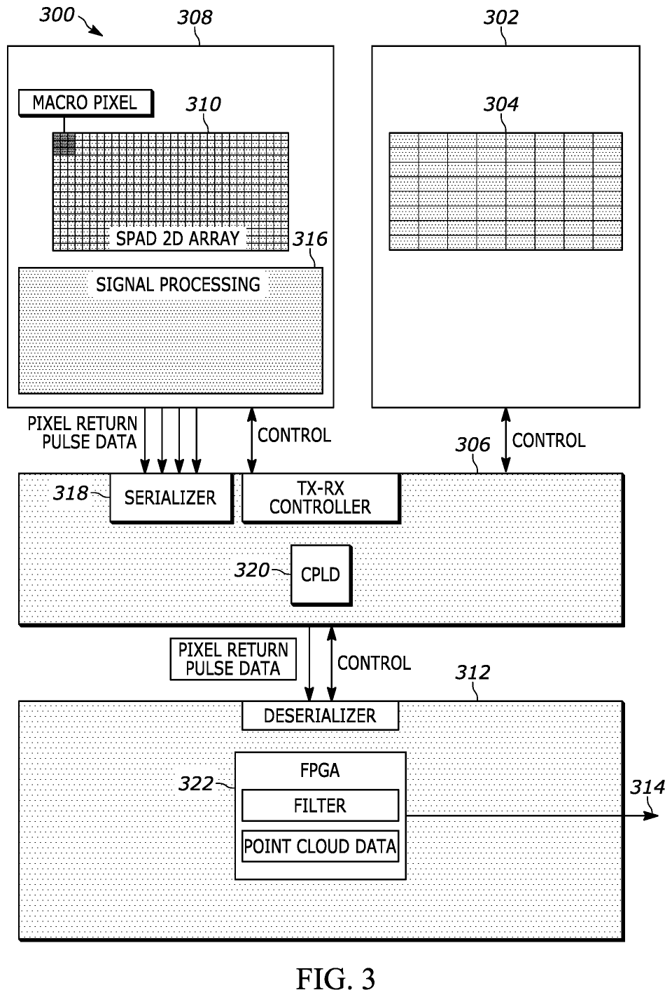

FIG. 3 illustrates a block diagram of an embodiment of a LiDAR system 300 of the present teaching. A transmit module 302 that includes a two-dimensional array of emitters 304 is electrically connected to a transmit-receive controller 306. In some embodiments, the emitters 304 are vertical cavity surface emitting lasers (VCSEL) devices. The transmit module 302 generates and projects illumination at a target (not shown).

A receive module 308 includes a two-dimensional array of detectors 310 that is connected to the transmit-receive controller 306. In some embodiments the detectors 310 are SPAD devices. Individual elements of the detector 310 are sometimes referred to as pixels. The receive module 308 receives a portion of the illumination generated by the transmit module 302 that is reflected from an object or objects located at the target. The transmit-receive controller 306 is connected to a main control unit 312 that produces point cloud data at an output 314. A point cloud data point is produced from data from a valid return pulse.

The receive module 308 contains a 2D array of SPAD detectors 310 that is combined/stacked with a signal processing element (processor) 316. In some embodiments, detector elements other than SPAD detectors are used in the 2D array. The signal processing element 316 can be a variety of known signal processors. For example, the signal processing element can be a signal processing chip. The array of detectors 310 can be mounted directly on the signal processing chip. The signal processing element 316 does time-of flight (TOF) calculations and produces histograms of the return signals detected by the SPAD detectors 310. Histograms are representations of measured receive signal strength as a function of time, sometimes referred to as time-bins. For methods that use averaged measurements, a single, averaged, histogram maintains the sum of the return signals for each of the returns up to the specified average number. The signal processing element 316 also performs a finite impulse response (FIR) filtering function. The FIR filter is typically applied to the histogram before return pulse detection and return pulse values are determined.

The signal processing element 316 also determines return pulse data from the histograms. Here, the term “return pulse” refers to an assumed reflected return laser pulse and its associated time. The return pulses that are determined by the signal processing element can be true returns, meaning they are actual reflections from an object in the FOV, or false returns, meaning they are peaks in the return signal due to noise. The signal processing element 316 might only send return pulse data, not the raw histogram data to the transmit-receive controller 306. In some methods according to the present teaching, any received signal within a time bin that exceeds a chosen return signal threshold is considered a return pulse. For a given threshold value, there will be a general number of N return pulses in a received histogram exceeding that value. Generally, a system will report only up to some maximum number of return pulses. For example, in one particular method, the maximum number is five, with the strongest 5 return pulses typically being selected. This reporting of some number of return pulses can be referred to as a return pulse set. However, it should be understood that in various methods according to the present teaching, there is a range of return pulse numbers that could be returned. For example, the number of returned pulses could be three, seven, or some other number. In some methods, the user specifies the signal level threshold. However, in many other methods according to the present teaching, the threshold is determined adaptively by the signal processing chip 316 in the receiver module 308.

In some methods according to the present teaching, the signal processing element 316 also sends other data to the transmit-receive controller 306. For example, in some methods, the results of ambient light level calculations are sent as ambient levels to the transmit-receive controller 306.

The transmit-receive controller 306 has a serializer 318 that takes the multi-lane return pulse data channels from the signal processing chip 316 and converts them to a serial stream that can be propagated over long wires. In some methods, the multi-lane data is presented in a Mobile Industry Processor Interface (MIPI) data format. The transmit-receive controller 306 has a Complex Programmable Logic Device (CPLD) 320 that controls the laser firing sequence and pattern in the transmit module 302. That is, the CPLD 320 determines which lasers 304 in the array get fired and at what time. However, it should be understood that the present teaching is not limited to CPLD processors. A wide variety of known processors can be used in the controller 306.

The main control unit 312 also includes a field programmable gate array (FPGA) 322 that performs processing of the serialized return pulse data to produce a 3D point cloud at the output 314. The FPGA 322 receives the serialized return pulse data from the serializer 318. In some method according to the present teaching, the return pulse information that is calculated and sent to the FPGA includes the following data: (1) the maximum peak value of the return pulse; (2) time, in some cases a bin location (number) of a histogram that corresponds to the maximum peak value; and (3) the width of the return pulse, which might be reported as a “start time” and “end time” calculated in some fashion. For example, the width could be a start time when the signal level starts to exceed the threshold, and an end time when the signal level then stops exceeding the threshold. In various methods, other definitions for start and stop, such as PW50 or PW80 are used to determine when the thresholds are exceeded. In yet other methods, more complicated slope-based calculations may be used to determine when the thresholds are exceeded.

In many methods, the signal processing chip 316 additionally reports other LiDAR parameters such as ambient light level, ambient variance, and the threshold value. In addition, if the histogram binning is not static or defined ahead of time, then information on binning or timing is also sent.

Some methods according to the present teaching analyze the return pulse data using various algorithms. For example, if a return pulse exhibits two maximum peaks, instead of a single peak, the occurrence of two maximum peaks could be flagged for further analysis by an algorithm. Additionally, when the return pulse shape is not a well-defined smooth peak, the return pulse can also be flagged for further analysis by an algorithm. A decision to perform analysis on the algorithm can be made by the processing element 316 or some other processor. The results of the algorithm can then be provided to the main control unit 312.

The main control unit 312 can be any processor or controller and is not limited to an FPGA processor. It should be understood that while only one transmit module 302 and receive module 308 are shown in the LiDAR system 300 of FIG. 3, multiple transmit and/or receive modules and associated transmit-receive controllers 306 can be electrically connected to one main control unit 312. Data may be presented as one, or more, point clouds at the output, based on the configuration of the LiDAR system 300. In many methods, the FPGA 322 also performs at least one of filtering functions, signal-to-noise ratio analysis, and/or standard deviation filter functions before generating the point cloud data. The main control unit 312 serializes resulting data with a serializer to provide the point cloud data.

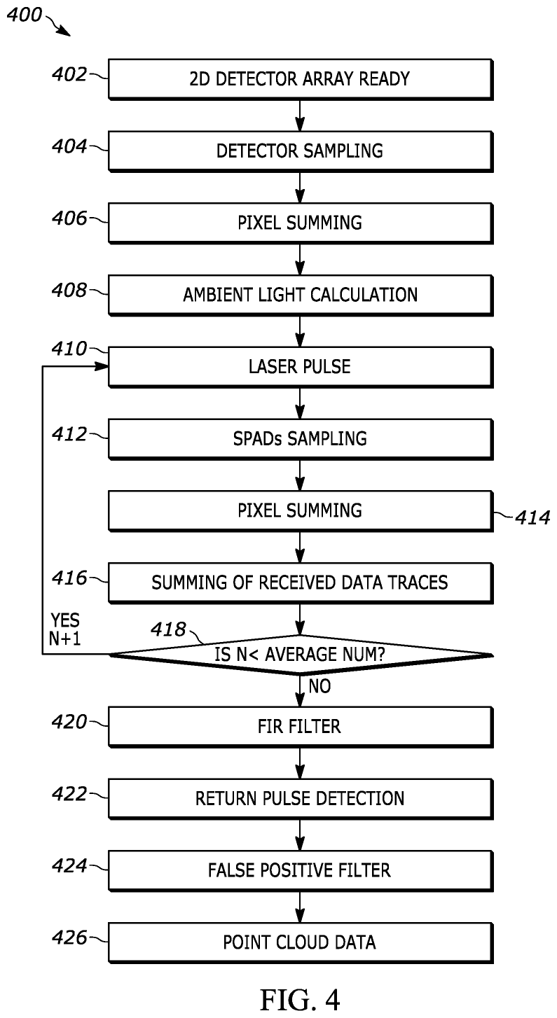

FIG. 4 illustrates a flow diagram of an embodiment of a LiDAR measurement method 400 that includes false positive filtering according to the present teaching. In a first step 402, a detector array in a receive module is initiated to be ready to operate.

In a second step 404, a number of detector elements in the array are sampled. For example, this may include one or more contiguous detectors that form a shape that falls within a FOV of a particular transmitter emitter device. This can also include sampling detectors that fall outside a FOV of one or more active transmitter elements. Referring back to FIG. 3 as an example, nine detector elements 310 fall within a particular illumination region of an emitter 304. Numerous combinations of emitter illumination patterns and receive patterns are envisioned by the method and system of the present teaching. Sampling can include measuring the strength of the received signal in each detector. In this second step 404, no laser illumination is being transmitted.

In a third step 406, the pixels, or individual emitter element outputs are summed. In a fourth step 408, the summed output is used to calculate and determine an ambient light level and an ambient light variance. Referring back to FIG. 3, the ambient light level may be provided to the FPGA 322 in the main control unit 312 for use in processing.

In a fifth step 410, a laser pulse is fired from one or more emitters. Referring back to FIG. 3, in some methods, the laser pulse firing and the particular choice of emitter elements 304 to be fired is determined by the CPLD 320.

In a sixth step 412, the detector elements are sampled. In a seventh step 414, the pixels are summed. In an eight step 416, a histogram is generated. A histogram includes measurements from multiple laser firings that are summed, or averaged to provide a final histogram. In general, multiple laser pulses are fired to produce a given averaged histogram. The total number is referred to as an average number. For this disclosure, we assume that the Nth laser pulse is fired in step five 410.

In a decision step nine 418, it is determined whether the number, N, of fired laser pulses is less than the desired average number. If the decision is yes, the method proceeds back to step five 410, and a (N+1)^{th} pulse is fired. If the decision is no, the method proceeds to the tenth step 420 and the averaged histogram is filtered with a FIR filter.

In an eleventh step 422, a return pulse is detected from the filtered averaged histogram. Referring back to FIG. 3, in some embodiments, steps ten 420 and eleven 422 are performed by the processor 316 in the receive module 308. The return pulse results are provided to the transmit receive controller 306.

In a twelfth step 424, a false positive filter is applied to the return pulse data. In thirteenth step 426, point cloud data is generated using the filtered return pulse data. In general, the point cloud data may include filtered return pulse data from numerous emitters and detectors to generate a two and/or three-dimensional point cloud that show reflections from a target scene.

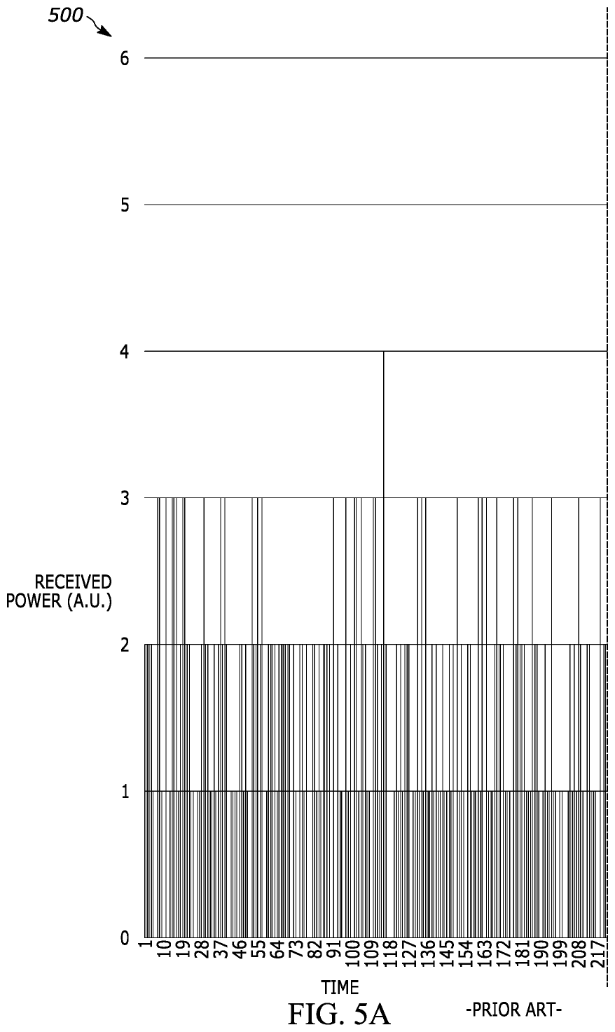

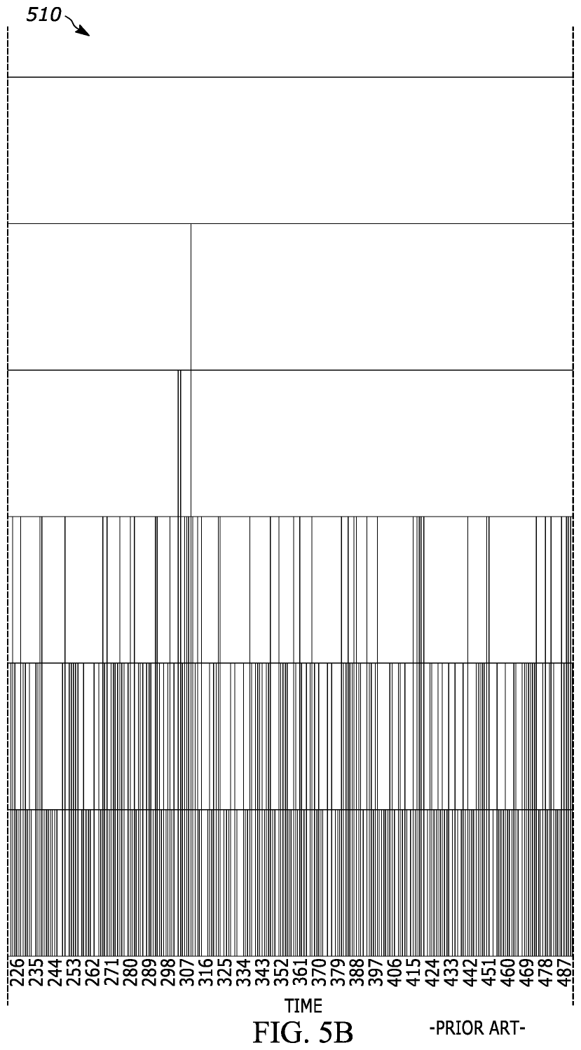

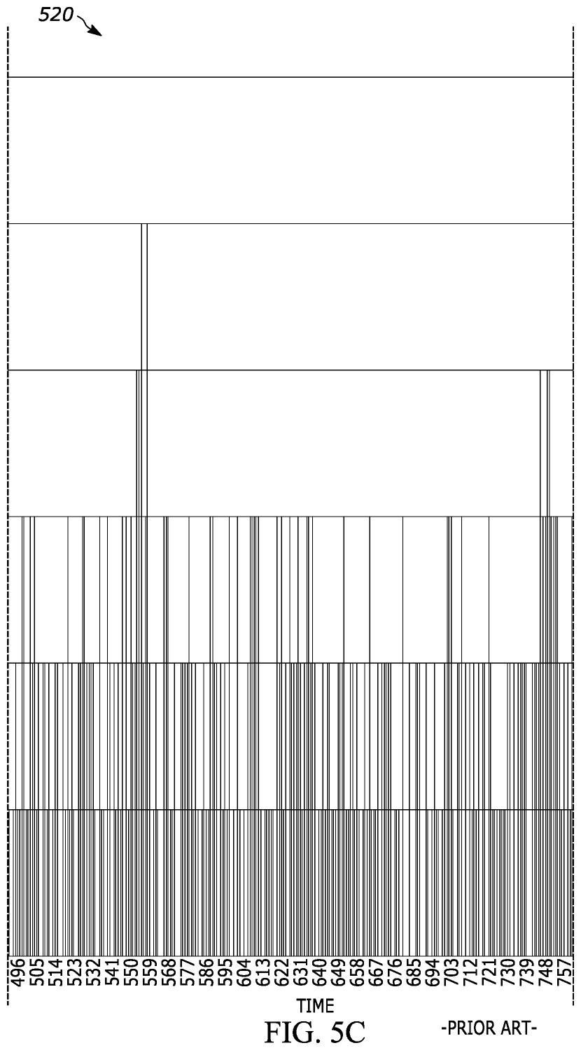

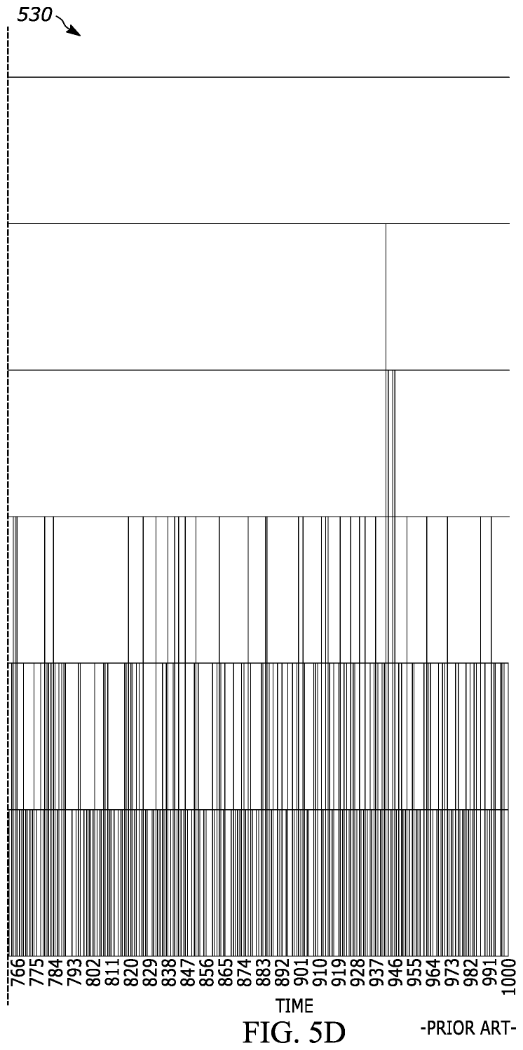

FIGS. 5A-5D are contiguous portions of a received data histogram that are broken into separate figures for clarity. FIG. 5A illustrates a first portion 500 of a received data trace from a known system and method of LiDAR measurement. FIG. 5B illustrates a second portion 510 of the received data trace from the known system and method of LiDAR measurement. FIG. 5C illustrates a third portion 520 of the received data trace from the known system and method of LiDAR measurement. FIG. 5D illustrates a fourth portion 530 of the received data trace from the known system and method of LiDAR measurement.

The portions 500, 510, 520, 530 of the received data histogram represent only background, or ambient light, as no illumination was provided for the detections in this particular received data. Thus, in this received data histogram, there is no “real” return pulse, only ambient noise. The peaks that are shown are merely generated by ambient light. This is particularly true when the detectors are SPAD devices because SPAD devices are very sensitive detectors, and thus false “return pulses” can be determined even when a laser pulse is not hitting anything in the detection range. Without some kind of filtering, these false “return pulses” will create a large number of false positive detections. This is particularly true in high sun loading scenarios.

One aspect of the present teaching is the use of false positive filtering in LiDAR systems. There are several types of false positive filters that are contemplated by the present teaching. One type of false positive filter is a signal-to-noise (SNR) ratio type filter. In SNR type filter, only return pulses with peak values that are N-times greater than the noise are considered valid return pulses.

A second type of false positive filter is a standard deviation filter. Standard deviation filters are sometimes also referred to as variance filters. In this filter, only received pulses with peak powers that are greater than the sum of the noise and N-times the standard deviation of the ambient noise are considered valid return pulses. In both these types of filters, the value of N may be adjusted to change a ratio of false-positive to false-negative results.

One feature of the SNR type filter is that it is easy to implement. For example, SNR type filters can be implemented based on an N^{th}-detected peak rather than on an average noise level (or ambient level). However, SNR type filters can be less accurate for high noise levels. One feature of the variance type filter is that it filters false positives very well in both low and high ambient light conditions. Consequently, properly configured variance type filters can correctly filter false positives in high ambient light scenarios. However, variance type filters require an accurate variance/standard deviation measurement and are generally more complicated to implement than a SNR type ratio filter.

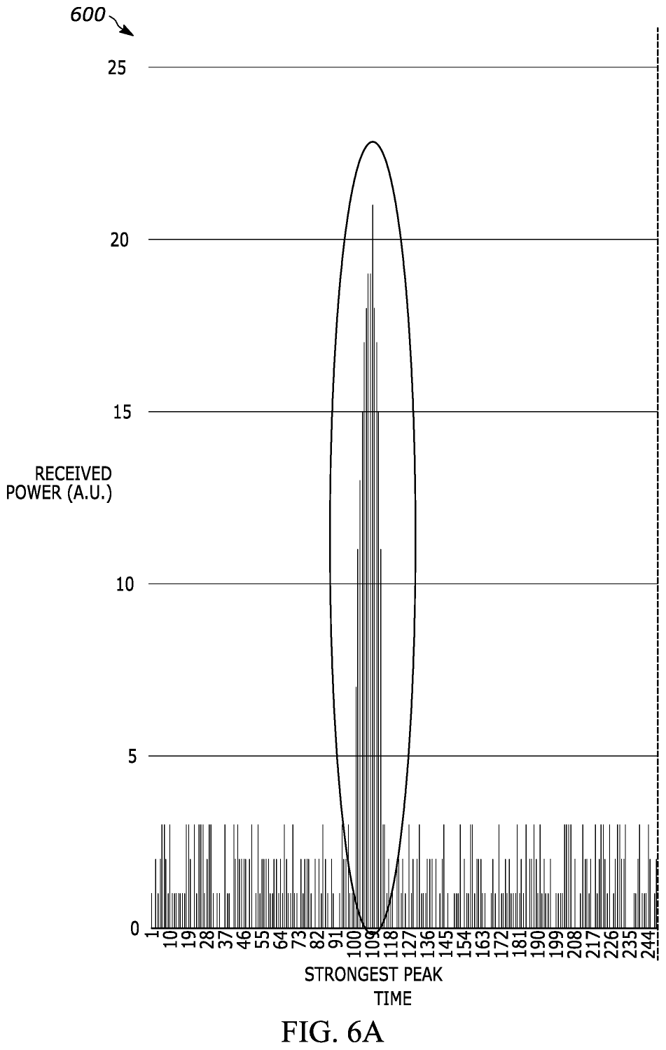

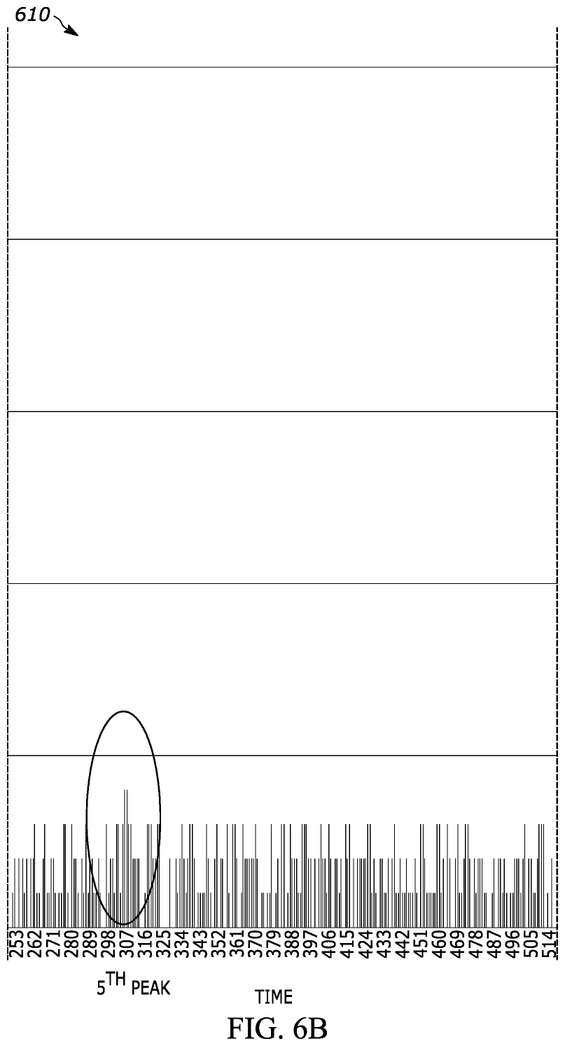

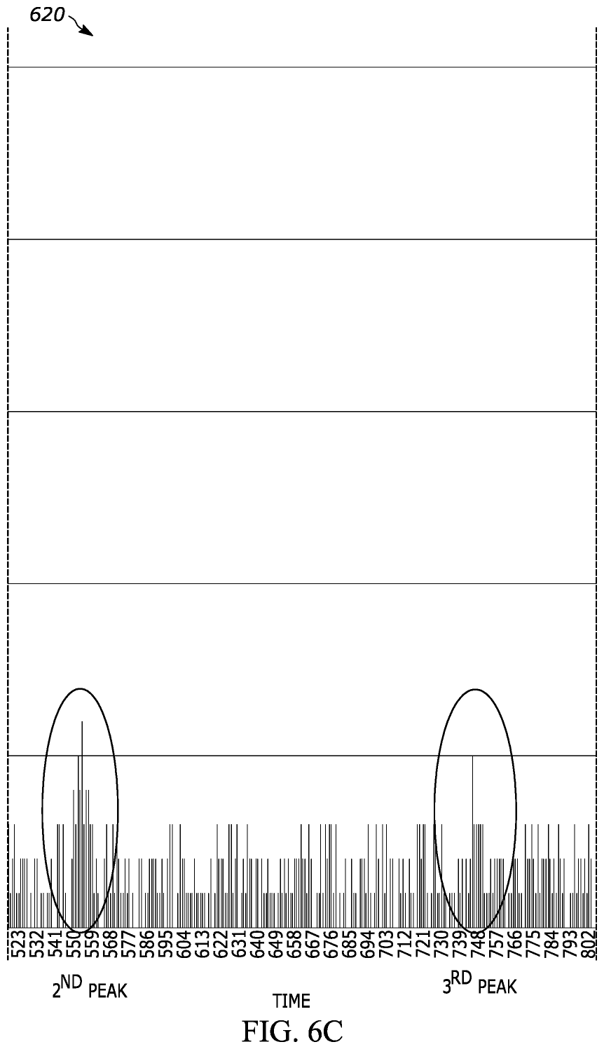

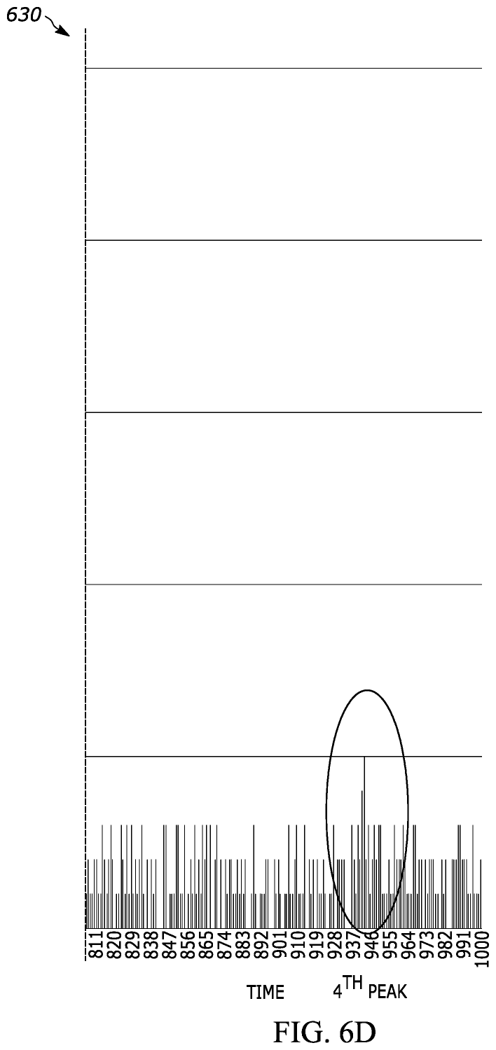

FIGS. 6A-D illustrate received data resulting from an implementation of an SNR type filter in a nominal ambient light condition according to the present teaching. The portions 600, 610, 620, 630 of received data are contiguous portions of the same histogram, and are broken into separate figures for clarity. FIG. 6A illustrates a first portion 600 of a received data trace subject to a method of signal-to-noise ratio filtering according to the present teaching. FIG. 6B illustrates a second portion 610 of the received data trace subject to the method of signal-to-noise ratio filtering according to the present teaching. FIG. 6C illustrates a third portion 620 of the received data trace subject to the method of signal-to-noise ratio filtering according to the present teaching. FIG. 6D illustrates a fourth portion 630 of the received data trace subject to the method of signal-to-noise ratio filtering according to the present teaching.

The strongest peak (circled in FIG. 6A) appears in the first portion 600. The fifth strongest peak (circled in FIG. 6B) appears in the second portion 610. The second and third strongest peaks (circled in FIG. 6C) appear in the third portion 620. The fourth strongest peak (circled in FIG. 6D) appears in the fourth portion 630.

Applying a signal-to-noise filter, with N selected accordingly, for the received data traces illustrated by portions 600, 610, 620, 630, only the two strongest peaks would be reported. These are illustrated in the first portion 600 and third portion 620. The ambient light level used to calculate N can be calculated based on the decision to exclude peaks three through five. Only the two peaks that have a peak power greater than N-times the ambient light level will be considered valid. The number N is chosen based on the desired false positive-to-false negative ratio. For low ambient light scenarios, where the standard deviation is approximately equal to the ambient level, the signal-to-noise ratio filter is not strong, as described herein. Thus, with a low ambient light scenario, it can be straightforward to pick a value for the number N that can provide a high confidence for excluding false positives, without rejecting true positive. For high ambient light scenarios, the standard deviation is much less than the ambient light level, and the signal-to-noise ratio filter is too strong because it requires very high peak power.

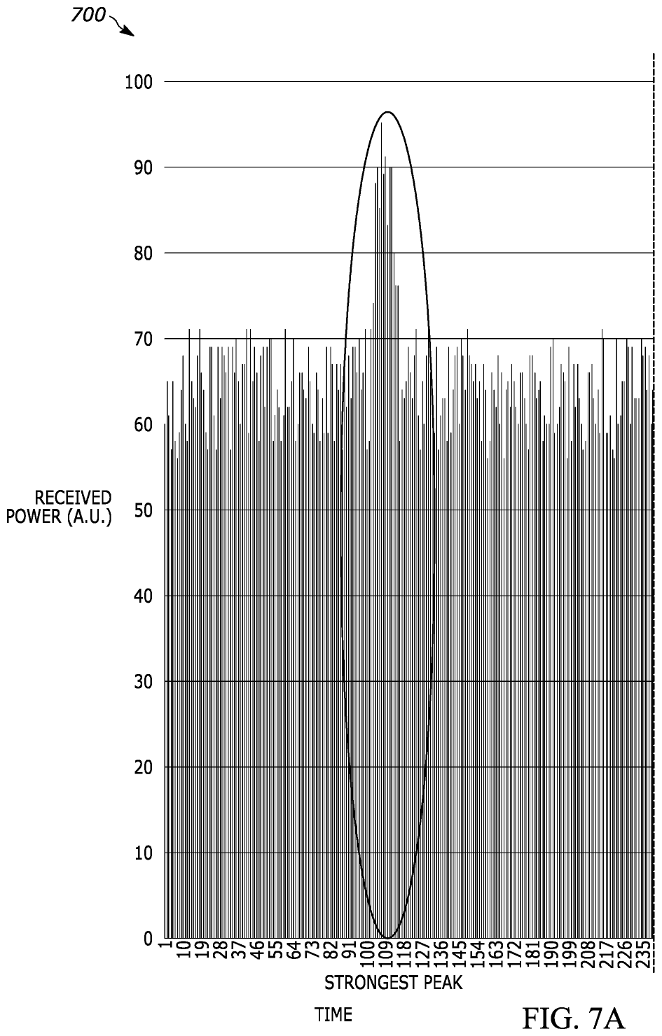

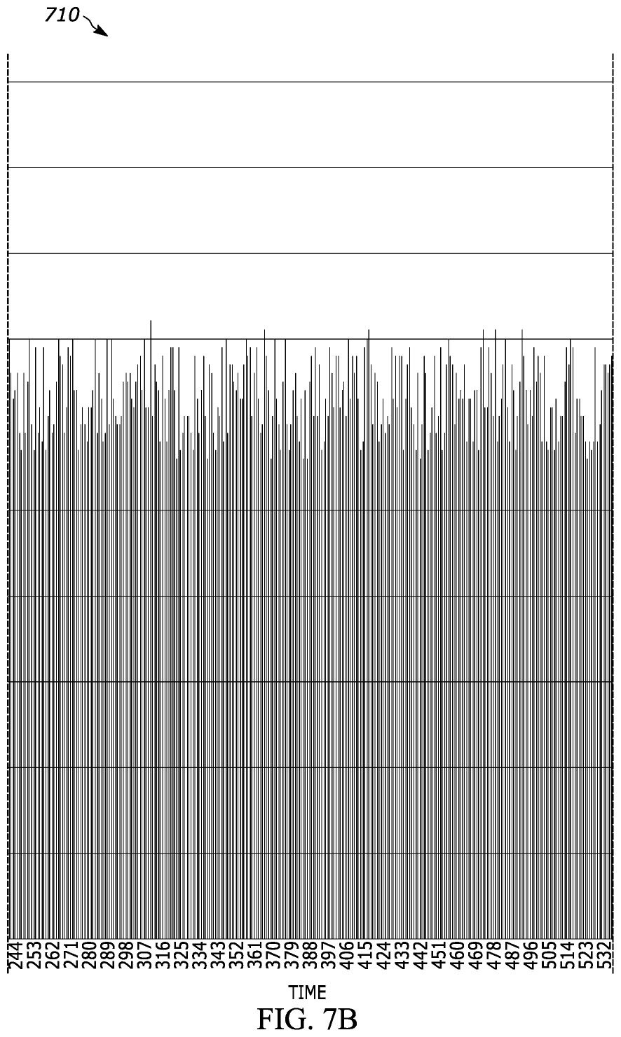

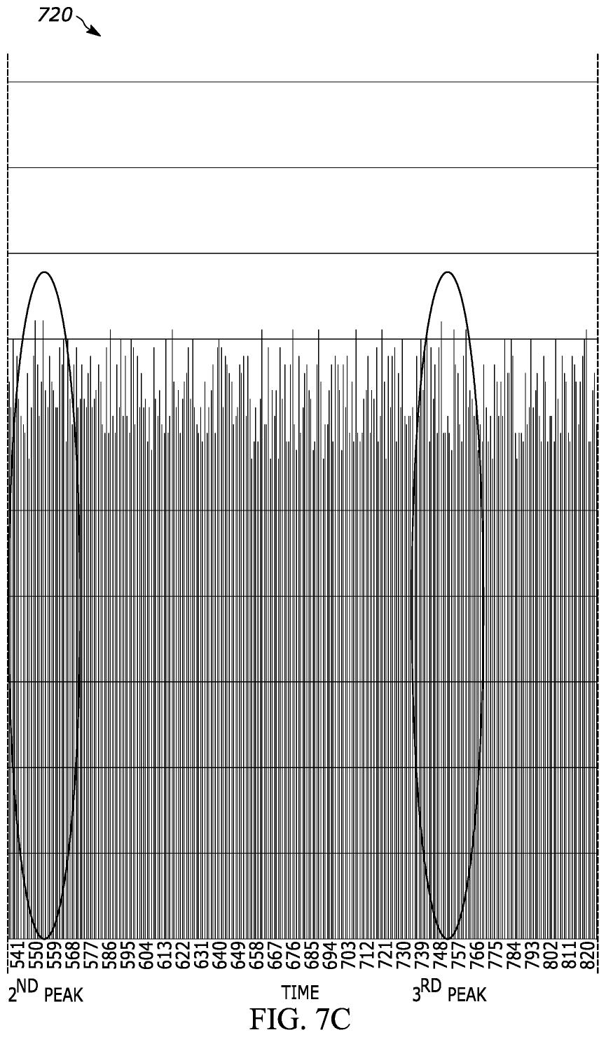

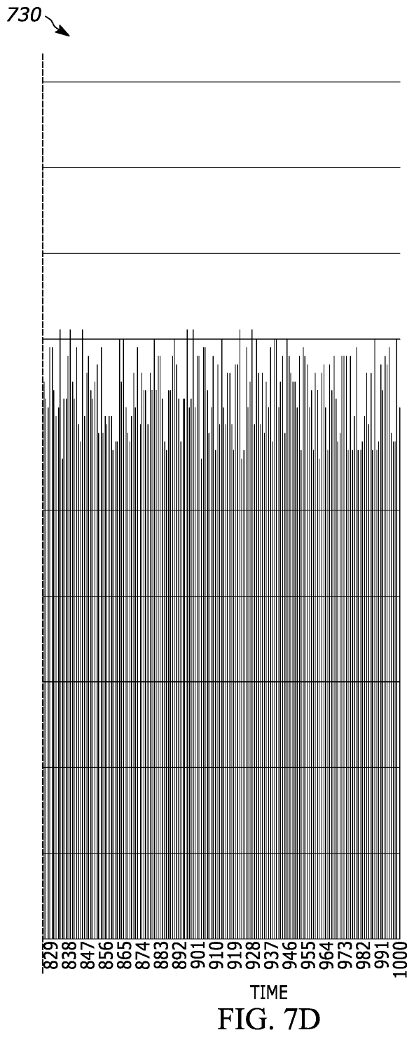

FIGS. 7A-D illustrate data resulting from an implementation of a signal-to-noise ratio filter according to the present teaching in a high ambient light condition. The portions 700, 710, 720, 730 of received data are contiguous portions of the same histogram, which are broken into separate figures for clarity.

FIG. 7A illustrates a first portion 700 of a received data trace subjected to signal-to-noise ratio filtering according to the present teaching with the measurement at high ambient light conditions. FIG. 7B illustrates a second portion 710 of the received data trace subjected to the signal-to-noise ratio filtering according to the present teaching with the measurement at high ambient light conditions. FIG. 7C illustrates a third portion 720 of the received data trace subjected to a signal-to-noise ratio filtering according to the present teaching with the measurement at high ambient light conditions. FIG. 7D illustrates a fourth portion 730 of the received data trace subject to a signal-to-noise ratio filtering according to the present teaching with the measurement at high ambient light conditions. The portions 700, 710, 720, 730 of the received data trace illustrate that only the strongest peak is large enough that a number for N can be selected that would pass that peak. It should be understood that N is not necessary an integer. The other valid peaks are eliminated. Thus, in high ambient light conditions the SNR filter can be prone to false negative results.

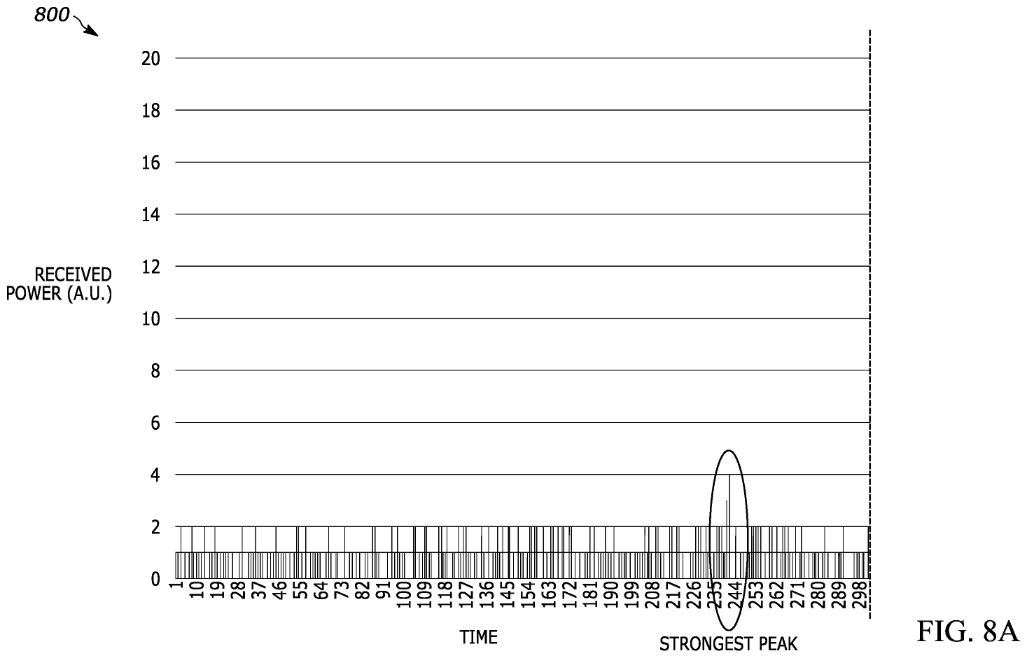

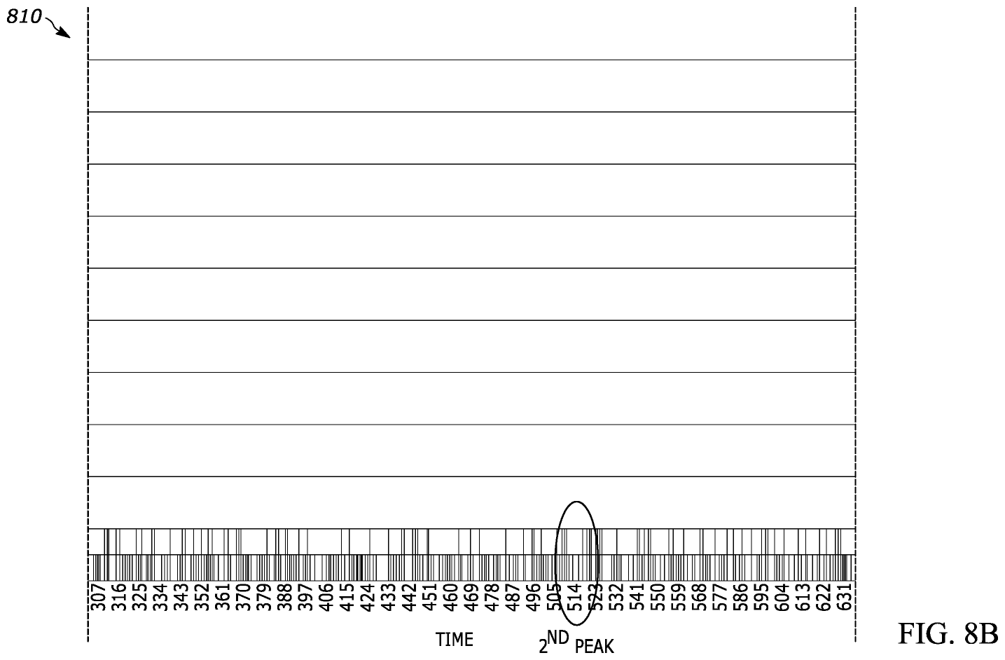

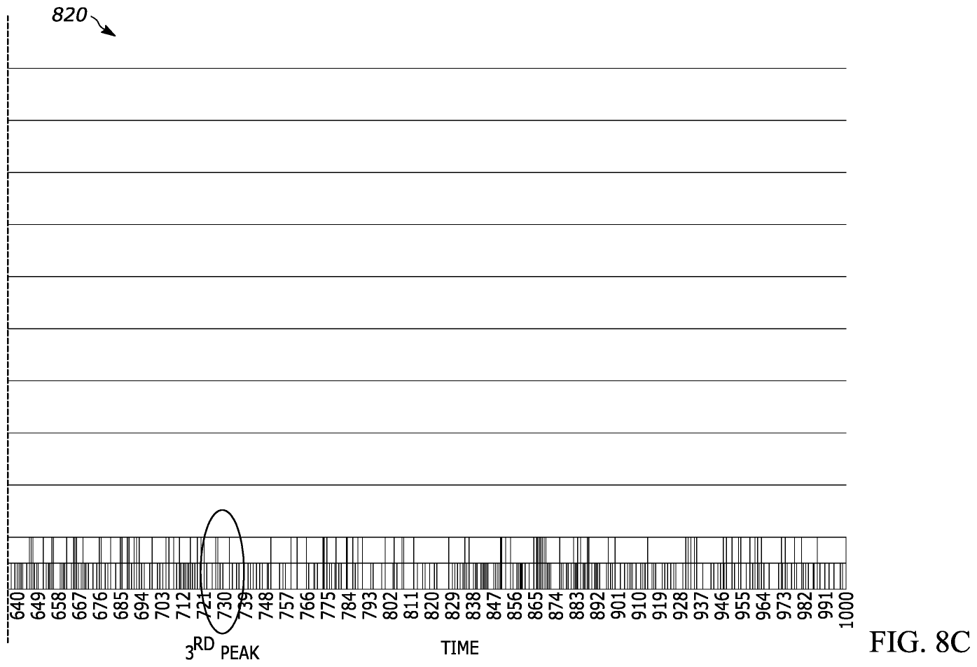

FIGS. 8A-C illustrate data that we analyze with a signal-to-noise ratio filter according to the present teaching in a low ambient light condition. The portions 800, 810, 820, 830 of received data are contiguous portions of the same received data histogram which are broken into separate figures for clarity.

FIG. 8A illustrates a first portion 800 of the received data trace subjected to signal-to-noise ratio filtering according to the present teaching with the measurement at low ambient light conditions. FIG. 8B illustrates a second portion 810 of the received data trace subjected to signal-to-noise ratio filtering according to the present teaching with the measurement at low ambient light conditions. FIG. 8C illustrates a third portion 820 of the received data trace subjected to signal-to-noise ratio filtering according to the present teaching with the measurement at low ambient light conditions. The portions 800, 810, 820 of the received data trace illustrate that in the low ambient conditions, the N*ambient condition causes false positive detections because “noise” is seen as a valid return pulse. Thus, the SNR filter can be prone to higher false positive results at low ambient light levels.

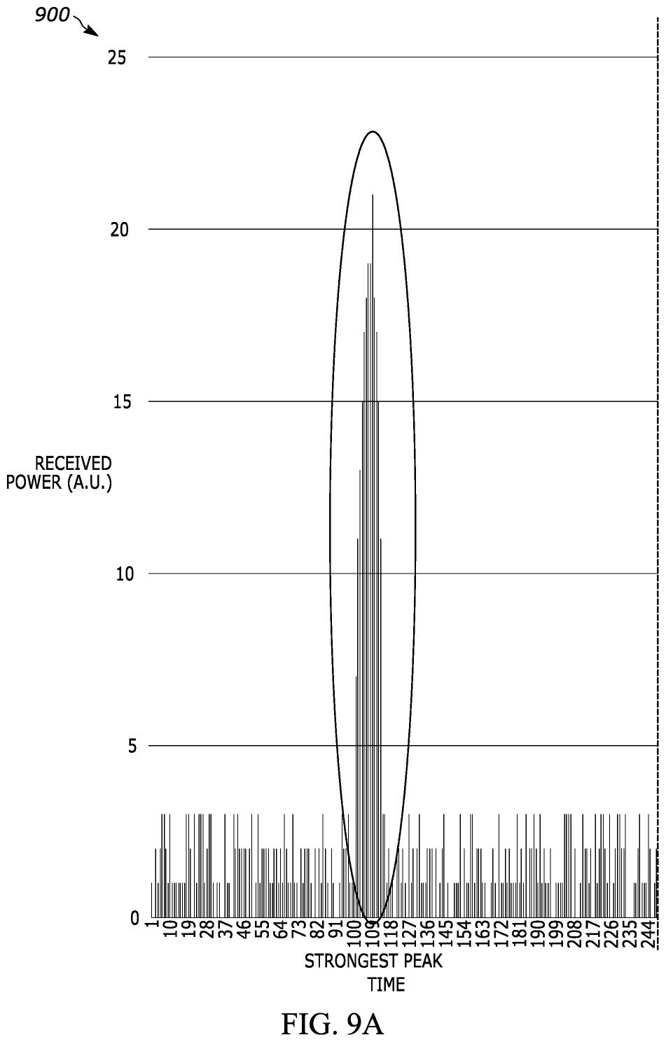

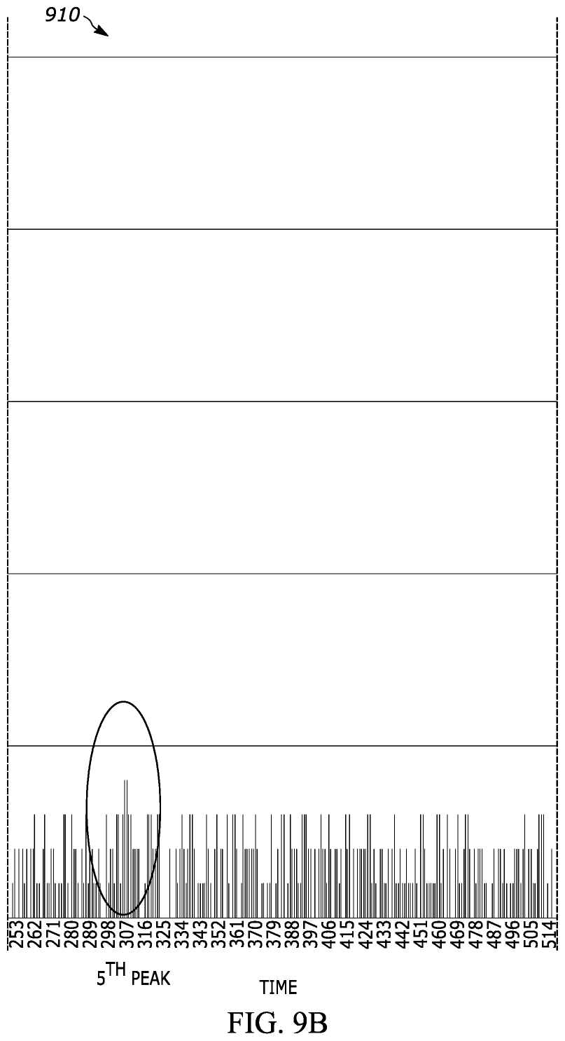

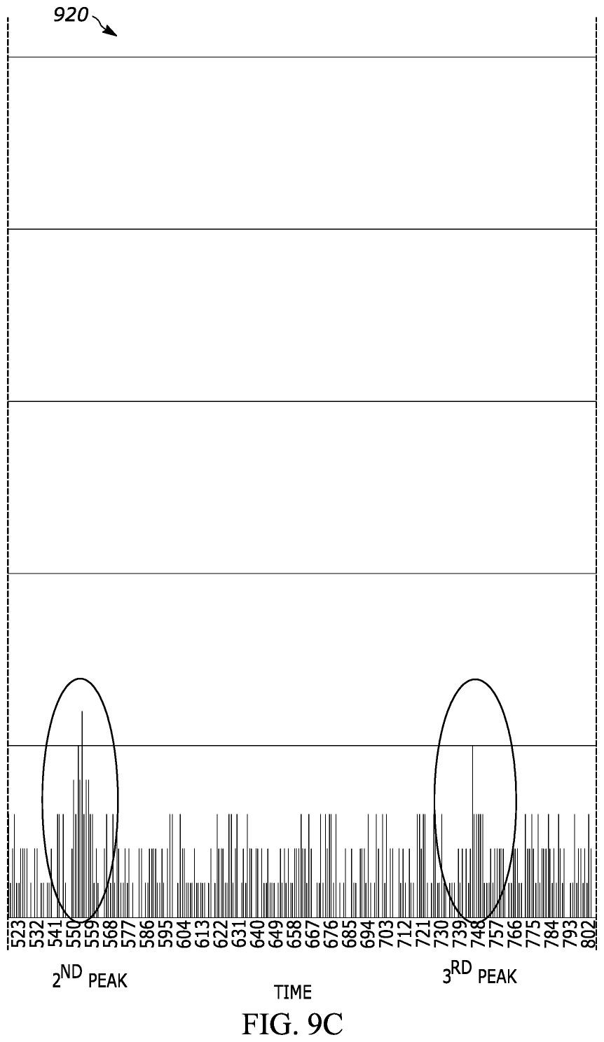

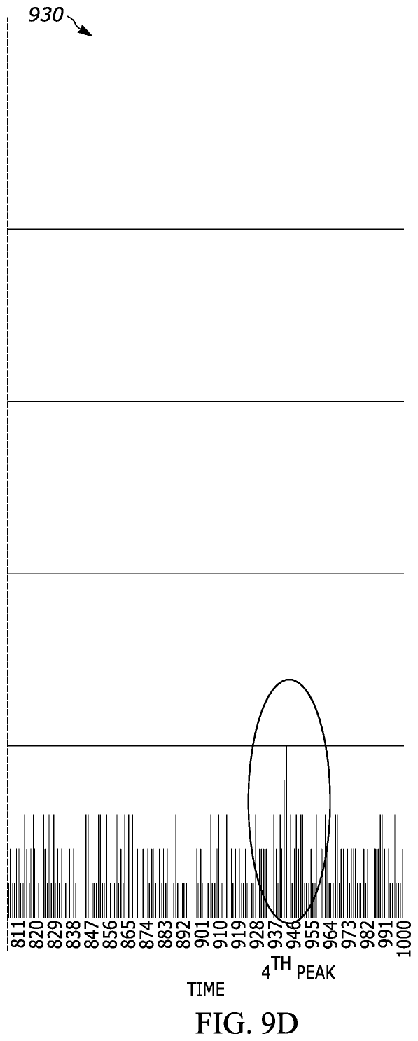

FIGS. 9A-D illustrate received data that we analyze with a standard deviation filter according to the present teaching in a nominal ambient light condition. It is well understood that standard deviation is the square root of the variance. The portions 900, 910, 920, 930 of received data are contiguous portions of the same histogram, which are broken into separate figures for clarity.

FIG. 9A illustrates a first portion 900 of a received data trace subjected to standard deviation filtering according to the present teaching with the measurement at normal ambient light conditions. FIG. 9B illustrates a second portion 910 of the received data trace subjected to standard deviation filtering according to the present teaching with the measurement at normal ambient light conditions. FIG. 9C illustrates a third portion 920 of the received data trace subjected to standard deviation filtering according to the present teaching with the measurement at normal ambient light conditions. FIG. 9D illustrates a fourth portion 930 of the received data trace subjected to standard deviation filtering according to the present teaching with the measurement at normal ambient light conditions.

Applying a standard deviation filter, with N selected accordingly, for the received data, only the two strongest peaks are reported. The variance is calculated based on the ambient light level measurements. Only return pulses with peak power that are greater than the ambient light level plus N times the standard deviation of the ambient light level are considered valid. This standard deviation filter works well at both high and low ambient light levels, as described further below. The variance and standard deviation are derived from the ambient light measurements.

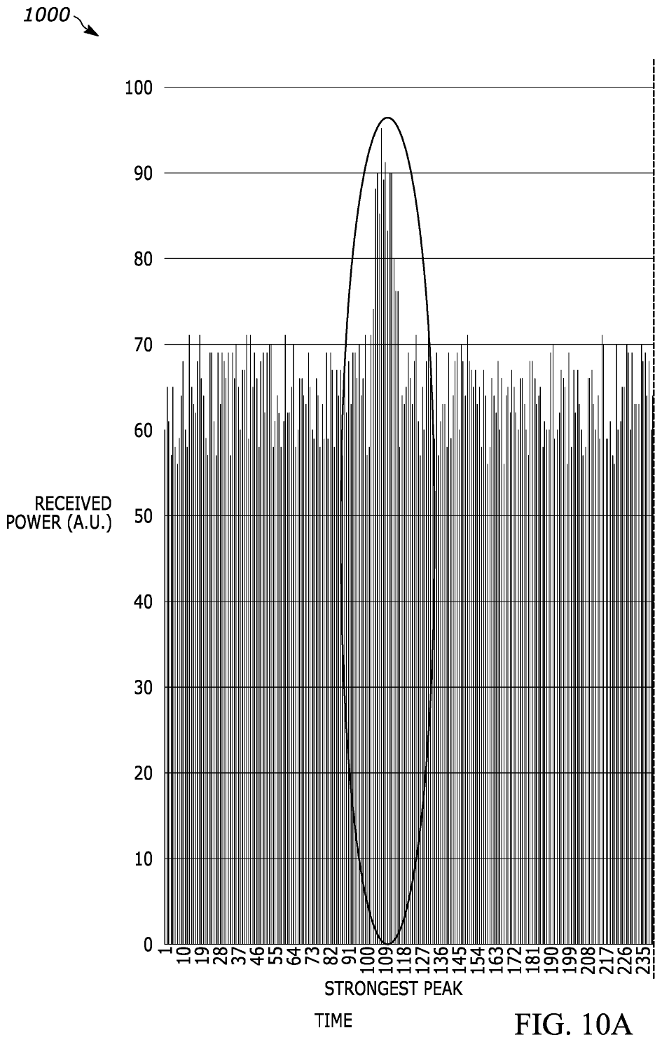

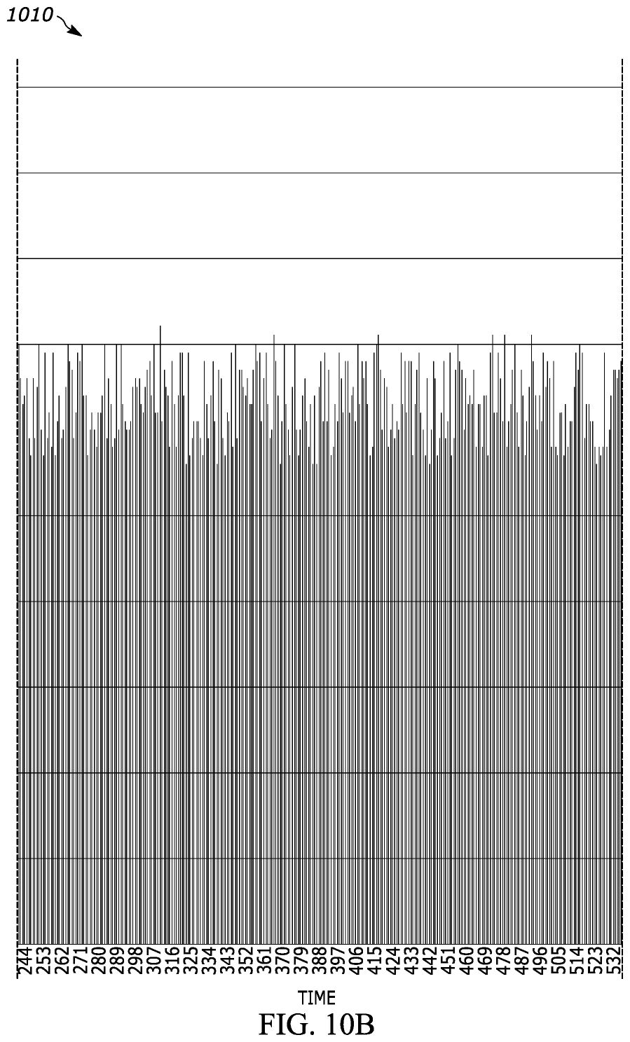

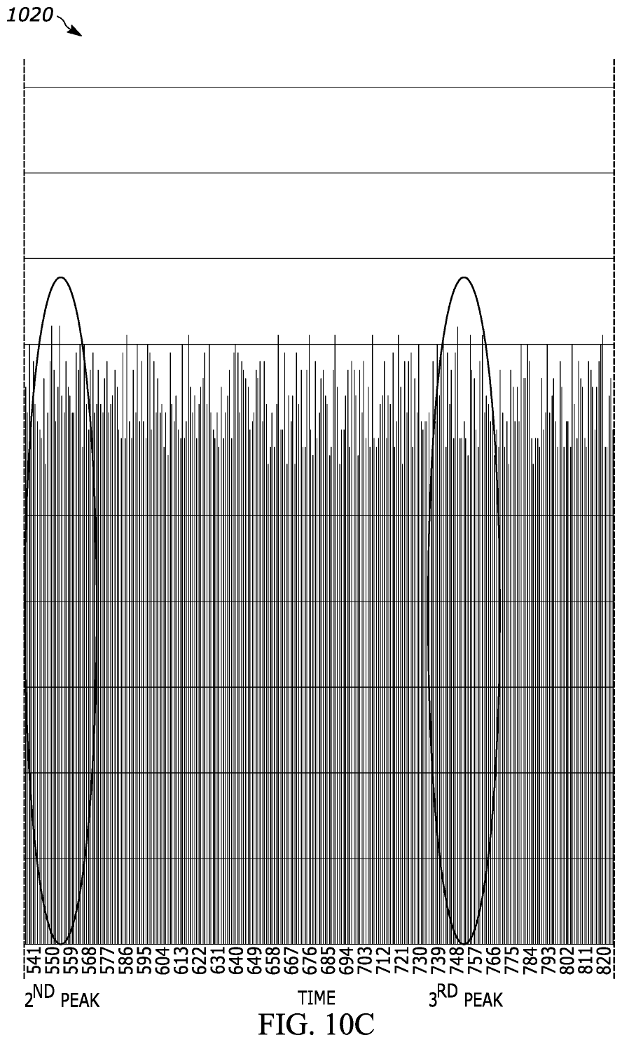

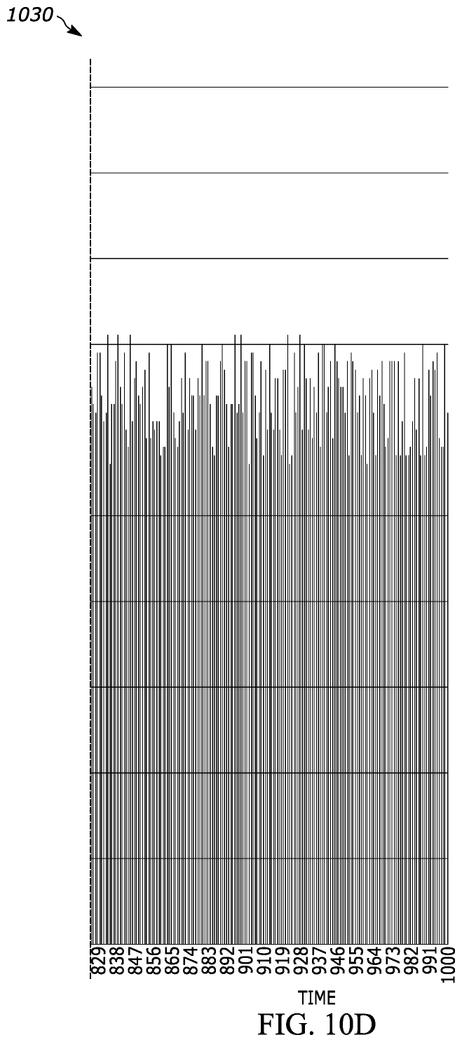

FIGS. 10A-D illustrate the received data analyzed with an implementation of a standard deviation filter of the present teaching in a high ambient light condition. The portions 1000, 1010, 1020, 1030 are contiguous portions of the same histogram, which are broken into separate figures for clarity.

FIG. 10A illustrates a first portion 1000 of a received data trace subjected to standard deviation filtering according to the present teaching with the measurement at high ambient light conditions. FIG. 10B illustrates a second portion 1010 of the received data trace subjected to standard deviation filtering according to the present teaching with the measurement at high ambient light conditions. FIG. 10C illustrates a third portion 1020 of the received data trace subjected to standard deviation filtering according to the present teaching with the measurement at high ambient light conditions. FIG. 10D illustrates a fourth portion 1030 of the received data trace subjected to standard deviation filtering according to the present teaching with the measurement at high ambient light conditions. In this high ambient light LiDAR measurement environment, selecting peaks with a magnitude that is greater than the ambient plus N times the standard deviation as a valid peak does not eliminate valid peaks.

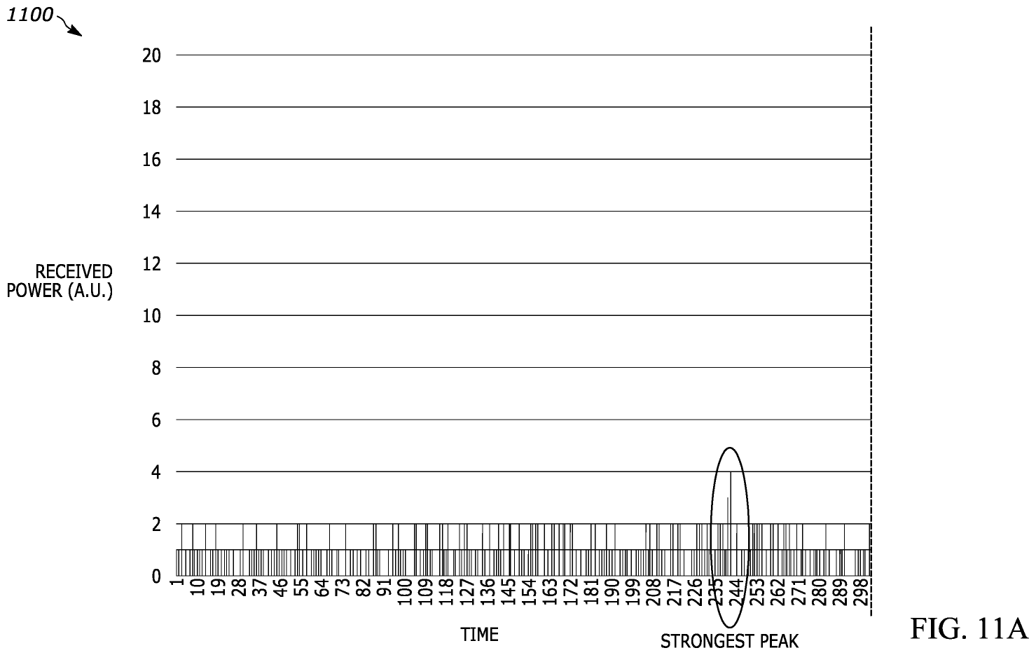

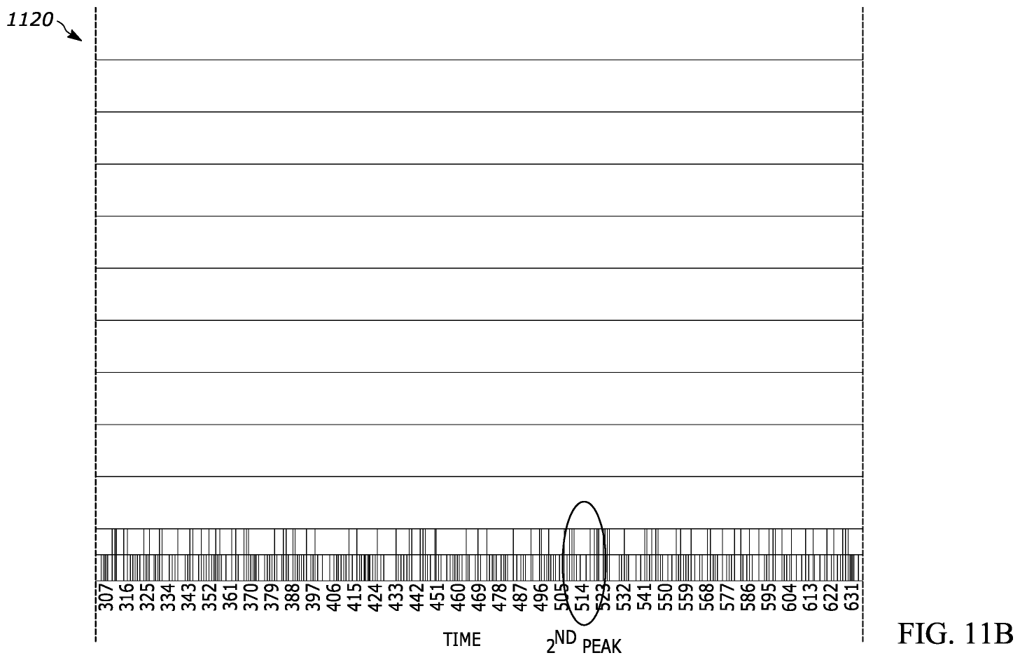

FIGS. 11A-B illustrate the data resulting from an implementation of a standard deviation filter in a low ambient light condition. The portions 1100, 1110 are contiguous portions of the same received data histogram, which are broken into separate figures for clarity.

FIG. 11A illustrates a first portion 1100 of a received data trace subjected to standard deviation filtering according to the present teaching with the measurement at low ambient light conditions. FIG. 11B illustrates a second portion 1110 of the received data trace subjected to standard deviation filtering according to the present teaching with the measurement at low ambient light conditions. In this low ambient light LiDAR measurement environment, selecting peaks with a magnitude that is greater than the ambient plus N times the standard deviation as a valid peak does eliminate invalid noise peaks.

Thus, both of the particular false positive reduction filters described herein according to the present teaching, the standard deviation filter and the signal-to-noise ratio filter, advantageously reduce the false positive rate of processed point cloud data in a LiDAR system. In addition, the standard deviation filter advantageously reduces false positive rates in low ambient light and improves false negative rates in high ambient light making it particular useful for LiDAR systems that must operate through a wide dynamic range of ambient lighting conditions.

The false positive reduction filters described herein can be employed in LiDAR systems in various ways. In some LiDAR systems according to the present teaching, the signal-to-noise ratio filter is the only false positive reduction filter that is used to reduce false positive measurements. In other systems according to the present teaching, the standard deviation filter is the only false positive reduction filter that is used to reduce false positive measurements. Referring back to method step twelve 424 of the method 400 of LiDAR measurement that includes false positive filtering described in connection with FIG. 4, the false positive filter would be either a signal-to-noise ratio filter or a standard deviation filter, depending on the particular method.

Some embodiments of signal-to-noise ratio filtering according to the present teaching require signal processing capabilities in the receiver block to perform additional calculations that are provided to a later processor in the LiDAR system. For example, referring to FIG. 3, the signal processing element 316 in the receive module 308 determines ambient light level and then provides this information to the FPGA 322 in the main control unit 312. Then, the FPGA 322 processes the signal-to-noise ratio filter data by calculating the value of N*ambient to choose valid peaks for the filtered data. The standard deviation filtering passes the return pulse information from the signal processing element 316 to the FPGA 322. The FPGA 322 determines the variance and standard deviation of the ambient light level data and then determines a signal peak that is N times the standard deviation to choose as a valid return pulse at the output of the false positive filter.

Thus, it should be understood that various embodiments of the noise filtering system and method for solid-state LiDAR according to the present teaching can determine ambient light and/or background noise in numerous ways. That is, the noise filtering system and method for solid-state LiDAR according to the present teaching can determine ambient light and/or background noise from a contiguous time sample of measurements of the detector element receiving the returned pulse. The noise filtering system and method for solid-state LiDAR according to the present teaching can also determine ambient light and/or background noise from a pre- or post-measurement of the ambient light and/or background noise made using the same detector element to obtain the pulse data. In addition, the noise filtering system and method for solid-state LiDAR according to the present teaching can determine ambient light and/or background noise from a detector element positioned immediately adjacent to the elements being used for the measurement, either before, after, or simultaneous with the pulsed measurement.

A further way that the noise filtering system and method for solid-state LiDAR according to the present teaching can determine ambient light and/or background noise is by taking measurements with detector elements within the detector array, which are not immediately adjacent to the detector elements used for the pulse measurement instead of using the same or adjacent detector elements as described in the various other embodiments herein. One feature of this embodiment of the present teaching is that it is sometimes advantageous to take measurements with detector elements that are positioned outside of the pulse illuminated region so that any received laser pulse signal level is below some absolute or relative signal level. In this way, the contribution from the received laser pulse to the ambient/background data record can be minimize.

Thus, in this embodiment of the present teaching, a laser pulse directed at a specific point in space with some defined FOV/beam divergence illuminates a region of the detector outside the region of imaging of any returned laser pulse. The received laser pulses are detected and the region of time corresponding to those pulses are excluded from the ambient noise/background noise calculation. The method of this embodiment requires the additional processing steps of determining the pulse location(s) in time, and then processing the received data to remove those times corresponding to possible returned pulses.

In one specific embodiment, a detector is physically positioned outside the region of imaging of any returned laser pulse. This configuration has the advantage that it could eliminate the need for some post-processing steps. This configuration also has the advantage that ambient light and/or background noise data sets can be taken simultaneously with the received pulse data set with the same number of points in time. Signal processing algorithms can be implemented to utilize these data. The features of this embodiment of the invention are described further in connection with the following figures.

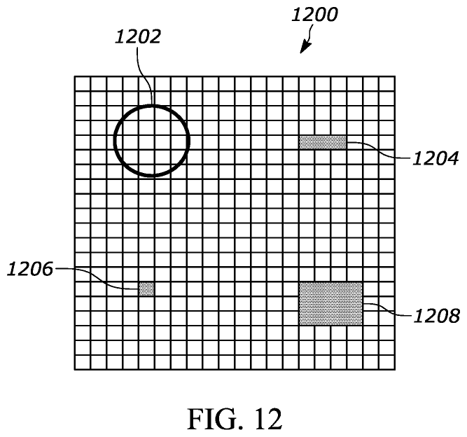

FIG. 12 illustrates various regions of a detector array 1200 used in an embodiment of the noise filtering system and method for solid-state LiDAR of the present teaching where measurement of ambient light and/or background noise are taken with detector elements within the detector array. There are various areas indicated in the detector array 1200. The circle 1202 indicates a region of the detector array 1200 which is illuminated by a reflected laser pulse that has been fired for purpose of range detection. A corresponding measurement of the ambient light and/or background noise is made with other portions of the detector array 1200. This corresponding measurement can be made before, after, or simultaneously with the received pulse measurement.

To illustrate the principles of the present teaching, three possible locations for the ambient noise measurement are shown in FIG. 12. The first location 1204 is positioned in the same row as the detector elements in the region of the detector array 1200 that is illuminated by the reflected laser pulse which has been fired for purpose of range detection. The second location 1206 is positioned in the same column as the detector elements in the region of the detector array 1200 that is illuminated by the reflected laser pulse which has been fired for purpose of range detection. The third location 1208 is positioned in different rows and different columns than the detector elements in the region of the detector array 1200 that is illuminated by the reflected laser pulse which has been fired for purpose of range detection. The figure illustrates that the size and number of elements in the detector array that are used for the ambient light and/or background noise measurement can be different from the size and number of elements in the detector array used for the received laser pulse.

In yet another embodiment of the noise filtering system and method for solid-state LiDAR of the present teaching, a second detector or detector array configured with a different field-of-view is used for the ambient light and/or background noise measurement instead of using the same detector array that is used for the received pulse measurement. In various embodiments, this second detector or detector array could be another detector array corresponding to a different field-of-view or a single detector element corresponding to a different field-of-view.

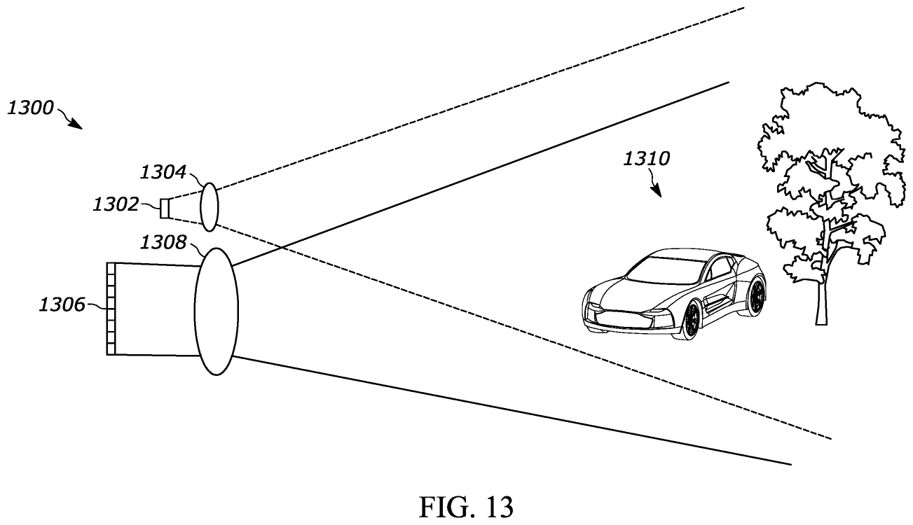

FIG. 13 illustrates a detector configuration 1300 for an embodiment of the noise filtering system and method for solid-state LiDAR of the present teaching where a second detector or detector array corresponding to a different field-of-view is used for the ambient light and/or background noise measurement. This second detector or detector array could be another detector array corresponding to a different field-of-view, or it could be a detector of different array dimension, including being a single detector element. In the particular embodiment shown in FIG. 13, a single detector 1302 and associated optics 1304 is used for the ambient light and/or background noise measurement. This single detector 1302 is separate from the detector array 1306 and associated optics 1308 that is used for the received pulse measurement.

In the configuration shown in FIG. 13, the single detector 1302 and associated optics 1304 is designed to have a much wider field-of-view of an environmental scene 1310 then a single detector element in the detector arrays described in other embodiments that are used for the received laser pulse measurement. One feature of the embodiment described in connection with FIG. 13 is that the optics 1304 can be configured with a wide enough field-of-view so that any laser pulse, no matter where it is directed within the field-of-view, is suppressed through the temporal averaging to a signal level below the ambient/noise signal level. Such a configuration can reduce or minimize the possibility of a laser pulse contributing significantly to the ambient light and/or background noise measurement.

It is understood that a separate or the same receiver can be used to process signals from the single detector or detector array 1302. It is also understood that a reflected laser pulse close enough in actual physical distance to any receiver within the same LiDAR system could be strong enough to be detected by all detectors, no matter their position in the detector array or as a separate detector. In such case, known signal processing methods be used to process the signals.

### Equivalents

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

What is claimed is:

1. A method of noise filtering light detection and ranging signals to reduce false positive detection, the method comprising:
a) detecting light generated by a light detection and ranging transmitter in an ambient light environment that is reflected by a target scene;
b) generating a received data trace based on the detected light;
c) determining an ambient light level based on the received data trace;
d) determining valid return pulses by comparing magnitudes of return pulses to a predetermined variable, N, times the determined ambient light level; and
e) generating a point cloud with a reduced false positive detection rate from the valid return pulses.

2. The method of claim 1 wherein the detecting light is performed with single photon avalanche diode detection.

3. The method of claim 1 further comprising determining the variable, N, corresponding to a desired ratio of false-positive-rate to false-negative-rate.

4. The method of claim 1 wherein the detecting light is performed with a detector array.

5. The method of claim 1 wherein the determining the ambient light level comprises sampling signals from a plurality of detector elements that correspond to a field-of-view of a particular transmitter element device in the light detection and ranging transmitter.

6. The method of claim 1 wherein the determining the ambient light level comprises sampling signals from a plurality of detector elements that are positioned outside of an illumination region.

7. The method of claim 1 further comprising determining valid return pulses by comparing magnitudes of return pulses to the predetermined variable, N, times the determined ambient light level using signal-to-noise filtering.

8. The method of claim 1 wherein the received data trace is generated from a histogram.

9. The method of claim 8 further comprising performing finite impulse response filtering on the histogram to determine the received data trace.

10. The method of claim 1 wherein the generating a point cloud comprising the plurality of data points comprises serializing return pulse data to produce a 3D point cloud.

11. A method of noise filtering light detection and ranging signals to reduce false positive detection, the method comprising:
a) detecting light generated by a light detection and ranging transmitter in an ambient light environment that is reflected by a target scene;
b) generating a received data trace based on the detected light;
c) determining an ambient light level based on the received data trace;
d) determining a variance of the ambient light level based on the received data trace;
e) determining valid return pulses by comparing magnitudes of return pulses to a sum of the ambient light level and N-times the variance of the ambient light level; and
f) generating a point cloud with a reduced false positive detection rate from the valid return pulses.

12. The method of claim 11 wherein the determining the variance comprises determining a standard deviation of the ambient light level.

13. The method of claim 11 wherein determining valid return pulses further comprises determining the standard deviation of the ambient light level.

14. The method of claim 11 wherein the received data trace is generated from a histogram.

15. The method of claim 14 further comprising performing finite impulse response filtering on the histogram to generate the received data trace.

16. The method of claim 11 wherein the detecting light is performed with single photon avalanche diode detection.

17. The method of claim 11 further comprising determining the variable, N, that corresponds to a desired ratio of false-positive-rate to false-negative-rate.

18. The method of claim 11 wherein the detecting light is performed with a detector array

19. The method of claim 11 wherein the determining the ambient light level comprises sampling signals from a plurality of detector elements that correspond to a field-of-view of a particular transmitter element device in the light detection and ranging transmitter.

20. The method of claim 11 wherein the determining the ambient light level comprises sampling signals from a plurality of detector elements that are positioned outside of an illumination region.

21. The method of claim 11 wherein the generating the point cloud comprises serializing return pulse data.

22. A light detection and ranging system with reduced false positive detection, the system comprising:
a) a transmit module comprising a two-dimensional array of emitters that generates and projects illumination at a target;
b) a receive module comprising a two-dimensional array of detectors that receive a portion of the illumination generated by the transmit module that is reflected from an object located at the target to generate a received data trace; and
c) a signal processor having inputs electrically connected to the output of the receive module, the signal processor performing time-of flight (TOF) calculations to produce histograms of the received data trace, determining an ambient light level based on the received data trace, determining valid return pulse data using the determined ambient light level, and generating a point cloud with a reduced false positive detection rate from the valid return pulses.

23. The light detection and ranging system of claim 22 wherein the two-dimensional array of emitters comprises two-dimensional Vertical Cavity Surface Emitting Lasers (VCSEL).

24. The light detection and ranging system of claim 22 wherein the receive module comprises a two-dimensional array of Single Photon Avalanche Diode Detectors (SPADS).

25. The light detection and ranging system of claim 22 further comprising a serializer coupled to the receive module that processes the received data trace.
